(19) United States
(12) Patent Application Publication
(10) Pub. No.: US 2022/0059081 A1
(43) Pub. Date: Feb. 24, 2022

(54) METHOD FOR UPDATING SPEECH RECOGNITION SYSTEM THROUGH AIR

(71) Applicant: National Chiao Tung University, Hsinchu (TW)

(72) Inventors: Sin Horng CHEN, Hsinchu (TW); Yuan Fu LIAO, Hsinchu (TW); Yih Ru WANG, Hsinchu (TW); Shaw Hwa HWANG, Hsinchu (TW); Bing Chih YAO, Hsinchu (TW); Cheng Yu YEH, Hsinchu (TW); You Shuo CHEN, Hsinchu (TW); Yao Hsing CHUNG, Hsinchu (TW); Yen Chun HUANG, Hsinchu (TW); Chi Jung HUANG, Hsinchu (TW); Li Te SHEN, Hsinchu (TW); Ning Yun KU, Hsinchu (TW)

(21) Appl. No.: 16/996,950

(22) Filed: Aug. 19, 2020

(51) Int. Cl. G10L 15/08; H04L 29/08

(52) U.S. Cl. CPC G10L 15/083; H04L 67/10; H04L 67/34

(57) ABSTRACT

The present invention provides a method for updating speech recognition system through air. Client ASR servers connect with a central ASR cloud server through Internet. New version of ASR system is stored in the central ASR cloud server for being selected and downloaded by the client ASR servers for using.

### FIELD OF THE INVENTION

The present invention relates to a method for updating speech recognition system, and more particularly to a method for updating speech recognition system through air.

### BACKGROUND OF THE INVENTION

Generally if a cloud Automatic Speech Recognition System (ASR) is going for updating, a professional must carry a USB flash drive to go into an engine room of controlling the cloud Automatic Speech Recognition System for updating. It is quite manpower and time consuming.

Since a cloud Automatic Speech Recognition System (ASR) is at the cloud, the updating of cloud ASR through air is more convenient. This technology is designed directly by the provider of cloud ASR system for being used by the clients. The new version of ASR is put by the provider at the cloud for being selected by the cloud ASR of the clients through Internet for using.

### SUMMARY OF THE INVENTION

The object of the present invention is to provide a method for updating speech recognition system through air, so that the client ASR servers are connected with a central ASR cloud server through Internet for selecting new version of ASR system. The present invention is described below.

The client ASR server provides cloud ASR system, and a central ASR cloud sever is set up for being connected with the client ASR server through Internet.

A new version of ASR system is put at the central ASR cloud sever for being selected by the client ASR server through Internet for using.

The steps for the new version of ASR system to parse speech are sequentially pre-processing for audio, extracting speech feature parameters, acoustic model and language model, in which the acoustic model and the language model are the main parts of the updating through air.

### BRIEF DESCRIPTION OF THE DRAWINGS

FIG. 1 shows schematically the main structure according to the present invention.

FIG. 2 show schematically the steps of the ASR system for parsing speech according to the present invention.

FIG. 3 shows schematically a flow chart of the cloud ASR system for selecting versions according to the present invention.

FIG. 4 shows schematically a flow chart of the ASR system for updating a new version through air according to the present invention.

### DETAILED DESCRIPTIONS OF THE PREFERRED EMBODIMENTS

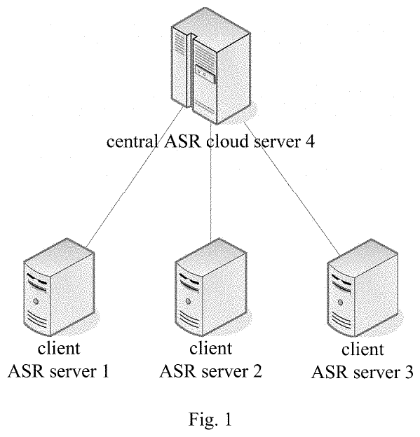

FIG. 1 describes the main structure according to the present invention. Client ASR server 1, client ASR server 2 and client ASR server 3 are systems for providing cloud automatic speech recognition, and are connected with a central ASR cloud server 4 of the present invention through Internet. The central ASR cloud server 4 of the present invention is designed directly by the provider of cloud ASR system for being used by the client ASR server 1, client ASR server 2 and client ASR server 3. The new version of ASR system is put by the provider at the central ASR cloud server 4 for being selected by the cloud ASR of the clients through Internet for using.

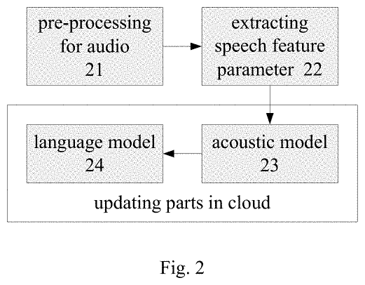

FIG. 2 describes the steps of the ASR system for parsing speech, sequentially pre-processing for audio 21, extracting speech feature parameter 22, acoustic model 23 and language model 24, in which the acoustic model 23 and the language model 24 are the main parts of the updating through air, the provider focuses on this technology, makes cloud updating simple, light and fast.

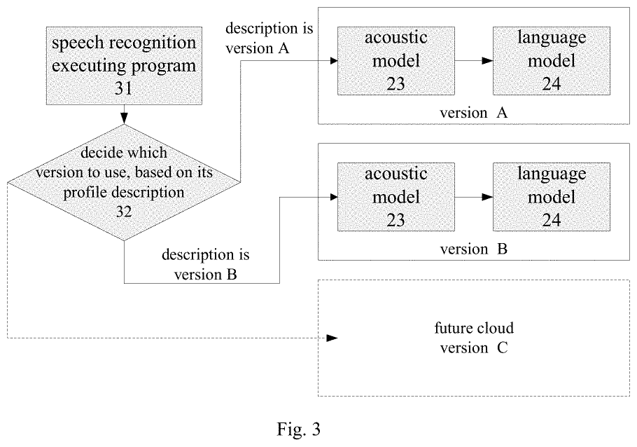

Referring to FIG. 3, a flow chart of the client ASR server 1, the client ASR server 2 and the client ASR server 3 for selecting versions is described. The speech recognition system firstly performs “speech recognition executing program” 31, then decide which version to use based on its profile description 32. If its profile description is version A, then go to select version A of acoustic model and language model; if its profile description is version B, then go to select version B of acoustic model and language model. If a new cloud version is going to be updated in the future, then prepare a place for version C.

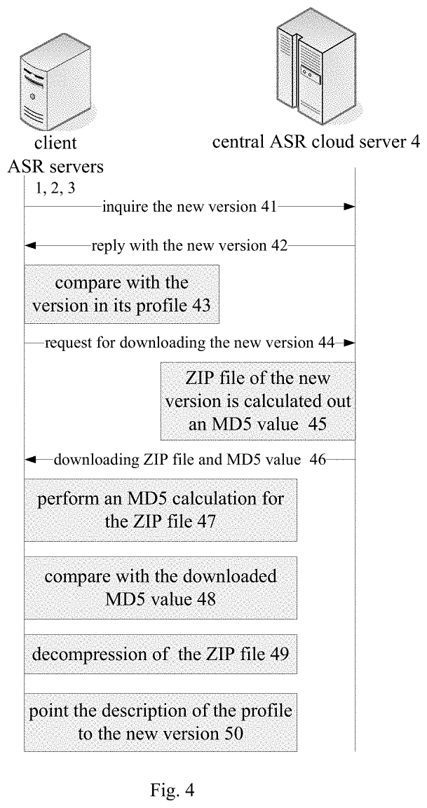

FIG. 4 describes a flow chart of the client ASR server 1, the client ASR server 2 and the client ASR server 3 for updating with the central ASR cloud server 4 through air according to the present invention. For example the client ASR server will actively inquire the central ASR cloud server 4 at 2 a.m. about a new version (step 41), the central ASR cloud server 4 replies its new version (step 42). The client ASR server will compare the version in its profile with the new version (step 43). If no difference, then the updating through air will not be performed. If different, the client ASR servet will request the central ASR cloud server 4 for downloading the new version (step 44).

The new version of the acoustic model 23 and the language model 24 has been packaged into a ZIP file by the central ASR cloud server 4, and an MD5 value will be calculated out for it (step 45), and then the ZIP file and the MD5 value will be downloaded to the client ASR server (step 46). The client ASR server performs an MD5 calculation for the downloaded ZIP file (step 47), and compare with the downloaded MD5 value (step 48). If the MD5 calculation is the same as the downloaded MD5 value, it means the ZIP file is completely downloaded.

Finally the client ASR server performs decompression of the ZIP file (step 49), and points the description of its profile to the new version (step 50), reboots the whole system to achieve the cloud updating.

The scope of the present invention depends upon the following claims, and is not limited by the above embodiments.

What is claimed is:

1. A method for updating speech recognition system through air, comprising steps as below:
(a) setting up at least a client ASR server for providing cloud automatic speech recognition, and setting up a central ASR cloud server for connecting with the client ASR server through Internet;
(b) a new version of automatic speech recognition system is put at the central ASR cloud server for being selected by the client ASR server through Internet for downloading and using.

2. The method for updating speech recognition system through air according to claim 1, wherein the client ASR server selects the new version of automatic speech recognition system through Internet, comprising communication steps of updating as below:
(a) the client ASR server actively inquire the central ASR cloud server about the new version;
(b) the central ASR cloud server replies with the new version;
(c) the client ASR server compares the new version with version in a profile thereof, if the same as the new version, then stop cloud updating;
(d) if different with the new version, the client ASR server requests the central ASR cloud server for downloading the new version.

3. The method for updating speech recognition system through air according to claim 2, wherein the client ASR server requests the central ASR cloud server for downloading the new version, comprising communication steps of updating as below:
(a) the new version has been packaged into a ZIP file by the central ASR cloud server, and an MD5 value thereof will be calculated out, and then the ZIP file and the MD5 value will be downloaded to the client ASR server;
(b) the client ASR server performs an MD5 calculation for the downloaded ZIP file, and compare with the downloaded MD5 value, if the MD5 calculation is the same as the downloaded MD5 value, it means the ZIP file is completely downloaded.
(c) the client ASR server performs decompression of the ZIP file, and points a description of the profile thereof to the new version, reboots whole system to achieve cloud updating.

4. The method for updating speech recognition system through air according to claim 3, wherein steps of the new version for parsing speech are sequentially a pre-processing for audio, a extracting speech feature parameter, an acoustic model and an language model, in which the acoustic model and the language model are the main parts of updating through air.
